(19) United States
(12) Patent Application Publication
(10) Pub. No.: US 2023/0022773 A1
(43) Pub. Date: Jan. 26, 2023

(54) Method for Link Selection, User Equipment, Network Node, and Telecommunication System

(71) Applicant: Telefonaktiebolaget LM Ericsson (publ), Stockholm (SE)

(72) Inventors: Jose Angel Leon Calvo, Aachen (DE); Zhang Zhang, Beijing (CN)

(21) Appl. No.: 17/785,587

(22) PCT Filed: Dec. 19, 2019
(86) PCT No.: PCT/CN2019/126470

§ 371 Date: Jun. 15, 2022

(51) Int. Cl. H04W 40/12; H04W 40/22

(52) U.S. Cl. CPC H04W 40/12; H04W 40/22

(57) ABSTRACT

The present disclosure provides methods for link selection in a telecommunication system, a user equipment, a network node, and a telecommunication system. The method comprises: communicating a probing message with a second UE via a relay link therebetween, both of the UEs being served by a same network node; determining whether uplink (UL) data is to be transmitted to the network node via the relay link or via an access link between the UE and the network node at least partially based on the link quality of the relay link, which is determined at least partially based on the probing message, and the link quality of the access link, or based on an indication from the network node; and transmitting the UL data via the determined one of the relay link and the access link.

### TECHNICAL FIELD

The present disclosure is related to the field of telecommunication, and in particular, to a method for link selection, a user equipment (UE), a network node (NN), and a telecommunication system.

### BACKGROUND

This section introduces aspects that may facilitate better understanding of the disclosure. Accordingly, the statements of this section are to be read in this light and are not to be understood as admissions about what is in the prior art or what is not in the prior art.

As a key supporting feature of autonomous driving which becomes increasingly popular in the recent years, Cellular-Vehicle-to-Anything (C-V2X) is drawing more attention than ever. C-V2X a part of the expansion of the 3GPP (3^{rd} Generation Partnership Project) LTE (Long Term Evolution) platform to new services, and it keeps track with the increasing needs of the automotive industry. Therefore, 3GPP is developing functionality to provide enhancements specifically for vehicular communications in terms of direct communication (between vehicles (V2V), vehicle to pedestrian (V2P), and vehicle to infrastructure (V2I)).

V2V communications are based on Device-to-Device (D2D) communications defined as part of ProSe services of the 3GPP specification. As part of ProSe services, a new D2D interface (designated as PCS, also known as sidelink (SL) at the physical layer) was introduced and now as part of the V2V work item, and it has been enhanced for vehicular use cases, specifically addressing high speed (up to 250 Kph) and high density (thousands of nodes).

In a typical V2X scenario, a UE may have multiple links for data/signaling transmission, such as an access link with its serving base station, one or more relay links with other UEs (e.g. V2V links with other nearby vehicles), etc. Therefore, a link selection mechanism is needed.

### SUMMARY

According to some embodiments of the present disclosure, a method, a user equipment, a network node, and a telecommunication system for link selection are provided.

According to a first aspect of the present disclosure, a method at a user equipment (UE) for link selection is provided. The method comprises: communicating a probing message with a second UE via a relay link therebetween, both of the UEs being served by a same network node; determining whether uplink (UL) data is to be transmitted to the network node via the relay link or via an access link between the UE and the network node at least partially based on the link quality of the relay link, which is determined at least partially based on the probing message, and the link quality of the access link, or based on an indication from the network node; and transmitting the UL data via the determined one of the relay link and the access link.

In some embodiments, the step of communicating a probing message with a second UE via a relay link therebetween comprises: transmitting the probing message to the second UE via the relay link.

In some embodiments, the probing message comprises information from which the link quality of the access link is derivable.

In some embodiments, the step of determining whether UL data is to be transmitted to the network node via the relay link or via the access link comprises: receiving, from the second UE, a response message comprising information from which the link quality of the relay link is derivable; deriving the link quality of the relay link at least partially based on the information; and determining whether UL data is to be transmitted to the network node via the relay link or via the access link at least partially based on the link quality of the relay link and the link quality of the access link.

In some embodiments, the step of deriving the link quality of the relay link at least partially based on the information comprises: determining the link quality of the relay link as being worse than the link quality of the access link in response to determining that the information is absent from the response message.

In some embodiments, the step of determining whether UL data is to be transmitted to the network node via the relay link or via the access link at least partially based on the link quality of the relay link and the link quality of the access link comprises: comparing the link quality of the relay link and the link quality of the access link; determining that the UL data is to be transmitted to the network node via the relay link in response to the comparison result indicating the link quality of the relay link being better than the link quality of the access link; and determining that the UL data is to be transmitted to the network node via the access link in response to the comparison result indicating the link quality of the relay link being worse than or equal to the link quality of the access link.

In some embodiments, the step of determining whether UL data is to be transmitted to the network node via the relay link or via the access link comprises: receiving, from the network node, a link selection indication message indicating whether the UL data is to be transmitted to the network node via the relay link or the access link.

In some embodiments, the step of communicating a probing message with a second UE via a relay link therebetween comprises: receiving the probing message from the second UE via the relay link.

In some embodiments, before the step of receiving the probing message from the second UE via the relay link, the method further comprises: transmitting, to the network node, a report message reporting the UE's energy status.

In some embodiments, the step of determining whether UL data is to be transmitted to the network node via the relay link or via the access link comprises: determining the link quality of the relay link at least partially based on the received probing message; comparing the link quality of the relay link and the link quality of the access link; determining that the UL data is to be transmitted to the network node via the relay link in response to the comparison result indicating the link quality of the relay link being better than the link quality of the access link; and determining that the UL data is to be transmitted to the network node via the access link in response to the comparison result indicating the link quality of the relay link being worse than or equal to the link quality of the access link.

In some embodiments, the step of determining whether UL data is to be transmitted to the network node via the relay link or via the access link comprises: determining the link quality of the relay link at least partially based on the received probing message; transmitting, to the network node, a link selection request message requesting link selection for the UE, the link selection request message comprising information from which the link quality of the relay link is derivable; and receiving, from the network node, a link selection response message indicating whether UL data is to be transmitted to the network node via the relay link or via the access link.

In some embodiments, the step of determining whether the UL data is to be transmitted to the network node via the relay link or via an access link at least partially based on the link quality of the relay link and the link quality of the access link comprises: determining whether the UL data is to be transmitted to the network node via the relay link or via an access link further based on at least one of: the willingness of the second UE being a relay UE; the capability of the second UE; and the power status of the second UE.

In some embodiments, the step of determining whether the UL data is to be transmitted to the network node via the relay link or via an access link comprises: comparing the link quality of the relay link plus an offset and the link quality of the access link, the offset indicating at least one of the willingness of the second UE being a relay UE, the capability of the second UE, and the power status of the second UE; determining that the UL data is to be transmitted to the network node via the relay link in response to the comparison result indicating the link quality of the relay link plus the offset being better than the link quality of the access link; and determining that the UL data is to be transmitted to the network node via the access link in response to the comparison result indicating the link quality of the relay link plus the offset being worse than or equal to the link quality of the access link.

In some embodiments, the method further comprises: communicating a second probing message between the UE and a third UE via a second relay link therebetween, both of the UE and the third UE being served by the same network node; determining whether UL data is to be transmitted to the network node via the relay link, the second relay link, or the access link at least partially based on the link quality of the relay link, the link quality of the second relay link, which is determined at least partially based on the second probing message, and the link quality of the access link, or based on an indication from the network node; and transmitting the UL data via the determined one of the relay link, the second relay link, and the access link.

In some embodiments, the step of determining whether the UL data is to be transmitted to the network node via the relay link, the second relay link, or the access link at least partially based on the link quality of the relay link, the link quality of the second relay link, and the link quality of the access link comprises: determining whether the UL data is to be transmitted to the network node via the relay link, the second relay link, or the access link further based on at least one of: the willingness of the third UE being a relay UE; the capability of the third UE; and the power status of the third UE.

In some embodiments, the step of determining whether the UL data is to be transmitted to the network node via the relay link, the second relay link, or the access link comprises: comparing the link quality of the relay link plus an offset, the link quality of the second relay link plus a second offset, and the link quality of the access link, the offset indicating at least one of the willingness of the second UE being a relay UE, the capability of the second UE, and the power status of the second UE, and the second offset indicating at least one of the willingness of the third UE being a relay UE, the capability of the third UE, and the power status of the third UE; determining that the UL data is to be transmitted to the network node via the relay link in response to the comparison result indicating the link quality of the relay link plus the offset being the best among all three link qualities; determining that the UL data is to be transmitted to the network node via the second relay link in response to the comparison result indicating the link quality of the second relay link plus the second offset being the best among all three link qualities; and determining that the UL data is to be transmitted to the network node via the access link in response to the comparison result indicating the link quality of the access link being the best among all three link qualities.

In some embodiments, the first offset is independent to the second offset.

In some embodiments, the step of determining whether UL data is to be transmitted to the network node via the relay link or via the access link further comprises: determining that at least a part of the UL control plane data is to be transmitted to the network node via the access link while the UL user plane data is to be transmitted to the network node via the relay link.

In some embodiments, the method further comprises: transmitting, to the network node, a resource allocation request message indicating the amount of UL data to be transmitted via the relay link.

In some embodiments, the resource allocation request message is one of a scheduling request (SR) message, a buffer status request (BSR) message, or a message requesting for allocation of one or more logical channels or logical channel groups.

In some embodiments, the method further comprises: receiving, from the network node, a resource allocation response message indicating the resources allocated to the second UE for forwarding the UL data; and transmitting, to the second UE, the resource allocation response message.

According to a second aspect of the present disclosure, a method at a second user equipment (UE) for facilitating link selection is provided. The method comprises: transmitting, to a network node which serves the second UE, a relay capability message indicating at least one of its willingness, its capability, and its power status for functioning as a relay UE.

In some embodiments, the method further comprises: receiving a probing message from a first UE, which is also served by the network node, via a relay link between the first UE and the second UE; determining the link quality of the relay link at least partially based on the received probing message; and transmitting, to the network node or the first UE, information from which the determined link quality of the relay link is derivable.

In some embodiments, the method further comprises: receiving, from the network node, a relay instruction message instructing the second UE to function as a relay UE for a first UE; and transmitting, to the first UE, a probing message from which the link quality of a relay link between the first UE and the second UE is derivable.

In some embodiments, the method further comprises: receiving, from the network node or the first UE, a message comprising resource allocation indicating resources allocated by the network node for relaying UL data for the first UE to the network node; and relaying the UL data from the first UE to the network node by using the allocated resources.

According to a third aspect of the present disclosure, a user equipment (UE) is provided. The UE comprises: a processor; a memory storing instructions which, when executed by the processor, cause the processor to perform the method of any of embodiments in the first and second aspects.

According to a fourth aspect of the present disclosure, a method at a network node for facilitating link selection is provided. The method comprises: receiving a message comprising information from which link quality of a relay link between a first user equipment (UE) and a second UE is derivable; determining whether uplink (UL) data to be transmitted by the first UE is to be transmitted to the network node via the relay link or via an access link between the UE and the network node at least partially based on the link quality of the relay link, which is determined at least partially based on the information, and the link quality of the access link; and transmitting, to the first UE, a link selection indication message indicating whether the UL data is to be transmitted to the network node via the relay link or the access link based on the result of the determination.

In some embodiments, the step of receiving a message comprising information from which link quality of a relay link between a first UE and a second UE is derivable comprises: receiving the message from at least one of the first UE and the second UE.

In some embodiments, the method further comprises: deriving the link quality of the relay link at least partially based on the information.

In some embodiments, the step of deriving the link quality of the relay link at least partially based on the information: determining the link quality of the relay link as being worse than the link quality of the access link in response to determining that the information is absent from the message.

In some embodiments, the step of determining whether UL data to be transmitted by the first UE is to be transmitted to the network node via the relay link or via the access link comprises: comparing the link quality of the relay link and the link quality of the access link; determining that the UL data is to be transmitted to the network node via the relay link in response to the comparison result indicating the link quality of the relay link being better than the link quality of the access link; and determining that the UL data is to be transmitted to the network node via the access link in response to the comparison result indicating the link quality of the relay link being worse than or equal to the link quality of the access link.

In some embodiments, the method further comprises: receiving, from the first UE, a report message reporting the first UE's energy status; determining whether the first UE needs a relay link at least partially based on its energy status; and transmitting, to the second UE, a relay instruction message instructing the second UE to function as a relay UE for the first UE.

In some embodiments, the method further comprises: receiving, from the first UE, a link selection request message requesting link selection for the first UE, the link selection request message comprising information from which the link quality of the relay link is derivable; determining whether the UL data is to be transmitted to the network node via the relay link or via the access link at least partially based on the information and the link quality of the access link; and transmitting, to the first UE, a link selection response message indicating the result of the determination.

In some embodiments, the step of determining whether the UL data is to be transmitted to the network node via the relay link or via the access link at least partially based on the link quality of the relay link and the link quality of the access link comprises: determining whether the UL data is to be transmitted to the network node via the relay link or via the access link further based on at least one of: the willingness of the second UE being a relay UE; the capability of the second UE; and the power status of the second UE.

In some embodiments, the step of determining whether the UL data is to be transmitted to the network node via the relay link or via the access link comprises: comparing the link quality of the relay link plus an offset and the link quality of the access link, the offset indicating at least one of the willingness of the second UE being a relay UE, the capability of the second UE, and the power status of the second UE; determining that the UL data is to be transmitted to the network node via the relay link in response to the comparison result indicating the link quality of the relay link plus the offset being better than the link quality of the access link; and determining that the UL data is to be transmitted to the network node via the access link in response to the comparison result indicating the link quality of the relay link plus the offset being worse than or equal to the link quality of the access link.

In some embodiments, the method further comprises: receiving another message comprising information from which link quality of a second relay link between the first UE and a third UE is derivable; determining whether the UL data is to be transmitted to the network node via the relay link, the second relay link, or the access link at least partially based on the link quality of the relay link, the link quality of the second relay link, which is determined at least partially based on the other message, and the link quality of the access link; and transmitting, to the first UE, a link selection indication message indicating whether the UL data is to be transmitted to the network node via the relay link, the second relay link, or the access link.

In some embodiments, the step of determining whether UL data is to be transmitted to the network node via the relay link or via the access link further comprises: determining that at least a part of the UL control plane data is to be transmitted to the network node via the access link while the UL user plane data is to be transmitted to the network node via the relay link.

In some embodiments, the method further comprises: receiving, from the first UE, a resource allocation request message indicating the amount of UL data to be transmitted via the relay link.

In some embodiments, the resource allocation request message is one of a scheduling request (SR) message, a buffer status request (BSR) message, or a message requesting for allocation of one or more logical channels (LCHs) or logical channel groups (LCGs).

In some embodiments, the method further comprises: transmitting, to the first UE or the second UE, a resource allocation response message indicating the resources allocated to the second UE for forwarding the UL data.

According to a fifth aspect of the present disclosure, a network node is provided. The network node comprises: a processor; a memory storing instructions which, when executed by the processor, cause the processor to perform the method of any of embodiments in the fourth aspect.

According to a sixth aspect of the present disclosure, a non-transitory computer readable storage medium comprising a computer program which, when executed by a processor, causes the processor to perform the method according to any of embodiments in the first, second, and fourth aspects.

According to a seventh aspect of the present disclosure, a telecommunication system is provided. The telecommunication system comprises one or more user equipments of any of embodiments in the third aspect and at least one network node of any of embodiments in the fifth aspect.

Additional aspects of the present disclosure will be set forth, in part, in the detailed description, figures, and any claims which follow, and in part will be derived from the detailed description, or can be learned by practice of the invention. It is to be understood that both the foregoing general description and the following detailed description are exemplary and explanatory only and are not restrictive of the present disclosure.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and therefore are not to be considered limiting of its scope, the disclosure will be described with additional specificity and detail through use of the accompanying drawings.

FIG. 1 is a diagram illustrating an exemplary V2X network in which multiple nodes are communicated with each other through different types of links according to an embodiment of the present disclosure.

FIG. 2 is a diagram illustrating an exemplary network in which a link selection scheme according to an embodiment of the present disclosure is applicable.

FIG. 3-FIG. 8 are diagrams illustrating exemplary methods for link selection in a form of message flow among the different nodes shown in FIG. 2 according to different embodiments of the present disclosure.

FIG. 9 is a diagram illustrating an exemplary hardware arrangement of a user equipment according to an embodiment of the present disclosure.

FIG. 10 is a diagram illustrating an exemplary hardware arrangement of a network node according to an embodiment of the present disclosure.

FIG. 11 is a diagram illustrating a computer readable storage medium having stored thereon a computer program comprising computer program code means according to an embodiment of the disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first” and “second,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

The terminology used herein is for the purpose of describing particular embodiments only and is not intended to be liming of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just means that there is an electrical or communicative connection between two elements and they can be connected either directly or indirectly, unless explicitly stated to the contrary.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

Of course, the present disclosure may be carried out in other specific ways than those herein set forth without departing from the scope and essential characteristics of the invention. One or more of the specific processes discussed below may be carried out in any communications transceiver comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the invention is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of Long Term Evolution (LTE) and/or New Radio (NR), the present disclosure is not limited thereto. In fact, as long as a D2D link or sidelink or any similar link is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division—Synchronous CDMA (TD-SCDMA), CDMA2000, Worldwide Interoperability for Microwave Access (WiMAX), Wireless Fidelity (Wi-Fi), etc. Therefore, one skilled in the arts could readily understand that the terms used herein may also refer to their equivalents in any other infrastructure.

In the present disclosure, the term “node” used herein may refer to a network node or a UE. Examples of network nodes may comprise but not limited to: NodeB, base station (BS), multi-standard radio (MSR) radio node such as MSR BS, eNodeB, gNodeB, MeNB, SeNB, integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g. MSC, MME etc.), O&M, OSS, SON, positioning node (e.g. E-SMLC), etc. Another example of a node is user equipment (UE), which is a non-limiting term and may refer to any type of wireless device communicating with a network node and/or with another UE in a cellular or mobile communication system. Examples of UE may comprise but not limited to target device, device to device (D2D) UE, vehicular to vehicular (V2V) equipment, machine type UE, MTC UE or UE capable of machine to machine (M2M) communication, PDA, Tablet, mobile terminals, smart phone, laptop embedded equipment (LEE), laptop mounted equipment (LME), USB dongles etc. Further, the term “gNB” used herein may refer to a base station, a base transceiver station, an access point, a hot spot, a NodeB, an Evolved NodeB (“eNodeB” or “eNB”), a network element, a network node, or any other equivalents.

In some embodiments, a generic term, “radio network node” or simply “network node (NW node or NN)”, is used. It can be any kind of network node which may comprise base station, radio base station, base transceiver station, base station controller, network controller, evolved Node B (eNB), Node B, gNodeB (gNB), relay node, access point, radio access point, Remote Radio Unit (RRU) Remote Radio Head (RRH), Central Unit (e.g. in a gNB), Distributed Unit (e.g. in a gNB), Baseband Unit, Centralized Baseband, C-RAN, access point (AP etc.

The term “radio access technology”, or “RAT”, may refer to any RAT e.g. UTRA, E-UTRA, narrow band internet of things (NB-IoT), WiFi, Bluetooth, next generation RAT, New Radio (NR), 4G, 5G, etc. Any of the equipment denoted by the terms node, network node, or radio network node may be capable of supporting a single or multiple RATs.

The term “signal” used herein can be any physical signal or physical channel. Examples of physical signals are reference signal such as PSS, SSS, CSI-RS, DMRS, signals in SSB, CRS, PRS, SRS etc. The term “physical channel” used herein is also called as “channel”, which contains higher layer information e.g. logical channel, transport channel etc. Examples of physical channels are MIB, PBCH, PSCCH, PSSCH, PDCCH, PDSCH, PUSCH, PUCCH etc.

The term “time resource” used herein may correspond to any type of physical resource or radio resource expressed in terms of length of time. Examples of time resources are: symbol, time slot, subframe, radio frame, TTI, interleaving time, etc. The term “TTI” used herein may correspond to any time period over which a physical channel can be encoded and optionally interleaved for transmission. The physical channel is decoded by the receiver over the same time period over which it was encoded. The TTI may also interchangeably called as short TTI (sTTI), transmission time, slot, sub-slot, mini-slot, mini-subframe etc.

The term “time-frequency resource” used herein for any radio resource defined in any time-frequency resource grid in a cell. Examples of time-frequency resource are resource block, subcarrier, resource block (RB) etc. The RB may also be interchangeably called as physical RB (PRB), virtual RB (VRB) etc.

The term “link” or “radio link” used herein may correspond to a link used for cellular operation or for any type of D2D operation. Examples of links used for cellular operations are links on Uu interface, uplink (UE transmission to BS), downlink (BS transmission to UE), forward link (BS transmission to UE), reverse link (UE transmission to BS). Examples of links used for D2D operations are links on PCS, sidelink (from one UE to another UE e.g. SL for V2X).

Please note that the term “access link” used herein may refer to a link between a UE and its serving network node, the term “relay link” used herein may refer to a link between a UE and its relay node, and the term “redirection link” used herein may refer to a link between the relay node and its serving network node. Therefore, a redirection link of a transmitting UE may also be called as an access link of its relay node which relays transmission between the transmitting UE and the network node.

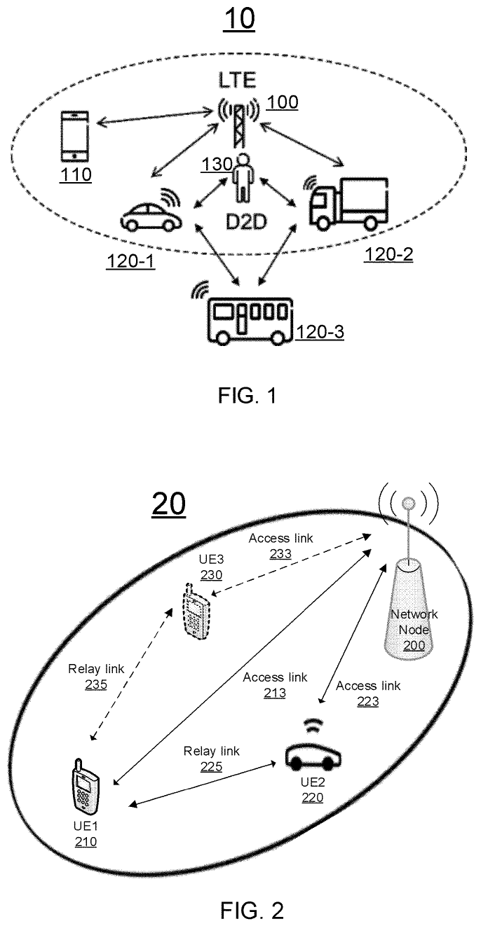

As mentioned above, LTE V2X was first specified by 3GPP in Release 14 and was enhanced in Release 15. LTE V2X consists of basic features and enhancements that allow for vehicular communications. One of the most relevant aspects is the introduction of direct vehicle-to-vehicle (V2V) communication functionalities. The specifications support other type of vehicle-to-anything (V2X) communications, including V2P (vehicle-to-pedestrian or pedestrian-to-vehicle), V2I (vehicle-to-infrastructure), etc., as shown in FIG. 1.

FIG. 1 is a diagram illustrating an exemplary V2X network 10 in which multiple nodes are communicated with each other through different types of links according to an embodiment of the present disclosure. As shown in FIG. 1, a V2X network 10 may comprise a network node (e.g. a gNB) 100 and multiple user equipments, such as a mobile phone 110, a pedestrian with a portable device (e.g. a smart watch) 130, and multiple vehicles of different types 120-1 (e.g. a sedan), 120-2 (e.g. a van), 120-3 (e.g. a bus). Please note that these nodes are only provided for illustrative purpose only, and therefore the present disclosure is not limited thereto.

As shown in FIG. 1, some of the UEs (e.g. those within the coverage of the network node 100) may communicate with the network node 100 via their access links, respectively, and some of the UEs (e.g. the sedan 120-1, the van 120-2, the bus 120-3, and the pedestrian 130) may communicate with each other directly via the D2D links therebetween.

These direct communication functionalities are built upon LTE D2D, also known as ProSe (Proximity Services), as first specified in the Release 12 of LTE, and include many important enhancements targeting the specific characteristics of vehicular communications. For example, LTE V2X operation is possible with and without network coverage and with varying degrees of interaction between the UEs and the NW (network), including support for standalone, network-less operation. For example, as shown in FIG. 1, the sedan 120-1 may communicate with other nodes (e.g. the pedestrian 130, the bus 120-3) directly via the direct link therebetween with or without the help of the network node 100. For another example, the bus 120-3 may communicate with other nodes (e.g. the sedan 120-1, the van 120-2) directly via the direct link therebetween without the help of the network node 100.

LTE V2X mainly targets basic road safety use cases like forward collision warning, emergency braking, roadworks warning, etc. Vehicle UEs supporting V2X applications can exchange their own status information such as position, speed, and heading, with other nearby vehicles, infrastructure nodes, and/or pedestrians. The typical messages sent by the vehicles are Co-operative Awareness Message (CAM) and Decentralized Environmental Notification Message (DENM), defined by ETSI, or Basic Safety Message (BSM), defined by the SAE (Society of the Automotive Engineers).

Further, 3GPP has started a new study item (SI) in August 2018 within the scope of Rel-16 to develop an NR version of V2X communications. The NR V2X will mainly target advanced V2X services, which can be categorized into four use case groups: vehicles platooning, extended sensors, advanced driving, and remote driving. The advanced V2X services would require enhanced NR system and new NR sidelink to meet stringent requirements in terms of latency and reliability. NR V2X system also expects to have higher system capacity and better coverage and to allow for easy extension to support the future development of further advanced V2X services and other services.

In the traditional specific National Security and Public Safety (NSPS) communication systems such as TETRA, the data rates were in the order of a few kbit/s at most, which do not provide support for the foreseen NSPS use case scenarios. Moreover, the NSPS use case requires an enhanced coverage and high reliability for its communications. Therefore, NSPS is a particularly interesting case for NR since it can provide the required robustness in the communications and the ability to communicate even in the cases where a fixed infrastructure is not installed.

Some of the scenarios where NSPS communication has no support from infrastructure are such as tunnels, inside some buildings or in emergency situations where the infrastructure is destroyed or non-operative. Even though in some of these cases, cellular coverage can be provided using some mobile stations, e.g., the van 120-2 with a portable base station installed as shown in FIG. 1, the implementation of sidelink communications can be beneficial in NSPS. Among the requirements for NSPS, one main topic is the group communication for NSPS in cases such as, a group of workers in a building.

The scenarios which are considered for NSPS include in-coverage scenarios where network (e.g. eNB/gNB) is available and out-of-coverage scenarios where there is no infrastructure. For the out-of-coverage scenario the addition of sidelink for synchronization and communication among the users is foreseen, however, the inclusion of multi-hop sidelink has not been done in legacy communication systems.

In the current technology, there is no mechanism to adaptively select different paths or links, e.g., select SL interface instead of Uu interface, based on an energy consumption metric. This mechanism is needed since in a mesh environment, i.e., several UEs scattered through the cell or network, using a multi-hop connection, e.g., using D2D communication and later Uu interface, could be the best solution in terms of power saving or bandwidth usage.

In general, some embodiments of the present disclosure establish a mechanism to adaptively change the path/link to send/receive information to/from the network node, by using another UE(s) acting as relay, based on power saving/consumption metrics. In some embodiments, the relay UE may be selected at least partially based on energy availability and UE capabilities which are exchanged among all the UEs in the network, using SL transmissions, and with the gNB through the Uu interface.

In some embodiments, this solution allows low-power UEs to save energy while successfully perform the intended communication by using different communication links, e.g., forwarding information through other UEs acting as relays. Further, in some embodiments, there is no impact in the Uu interface communication, e.g., interference or collisions, since the network node may control and allocate the required resources for the multi-hop communication through the relay UE. Furthermore, in some embodiments, the selection of the relay UEs is performed adaptively, i.e., the relay UE may exchange its capabilities and accept the role of relay UE depending on its own power consumption and own resources availability without impact on its own normal operation.

The present disclosure is described below in the context of sidelink V2X communications. However, most of the embodiments are applicable to direct communications between UEs, in other scenarios involving device-to-device (D2D) communications such as NSPS. In this case, a remote UE which will act as the TX UE (e.g. UE1 210 shown in FIG. 2) and a relay UE which will forward the information (e.g. UE2 220 or UE3 230 shown in FIG. 2), and may have higher power than the remote UE are defined, both under coverage of the gNB. An exemplary scenario is shown in FIG. 2.

FIG. 2 is a diagram illustrating an exemplary network 20 in which a link selection scheme according to an embodiment of the present disclosure is applicable. As shown in FIG. 2, the network 20 may comprise a network node 200 (e.g. a gNB) and multiple UEs 210, 220, and optionally 230. However, the present disclosure is not limited thereto. For example, the network 20 may comprise more or less nodes, such as more than one network node 200 and/or any number of UEs.

As shown in FIG. 2, each of the UEs 210-230 may communicate with the network node 200 directly via their own access link or Uu interface. For example, UE1 210 may communicate with the network node 200 directly via the access link or Uu interface 213 therebetween, UE2 220 may communicate with the network node 200 directly via the access link or Uu interface 223 therebetween, and UE3 230 may communicate with the network node 200 directly via the access link or Uu interface 233 therebetween. Further, as also shown in FIG. 2, UE1 210 may communicate with the network node 200 indirectly via its relay link or side link SL 225 and the access link 223 of UE2 220. Similarly, UE1 210 may also communicate with the network node 200 indirectly via its relay link or side link SL 235 and the access link 233 of UE3 230.

Therefore, there are multiple paths or links for selection by UE1 210 to communicate with the network node 200. In some embodiments of the present disclosure, a path/link selection mechanism between the direct Uu path (or access link) and indirect Uu plus SL path (or relay link) with the goal of power saving from (at least) the perspective of the TX UE, or UE1, i.e., the UE initiating the communication, is described. As initial situation it is assumed that there is an active connection between the UEs (i.e. UE1 210, UE2 220, and optionally UE3 230) and the network node 200, i.e., the UEs are in RRC_CONNECTED state, and UE1 210 may communicate with the network node 200 via the access link 213. However, the present disclosure is not limited thereto. For example, the UEs may stay in other states (e.g. RRC_IDLE) and similar operations may be performed as well.

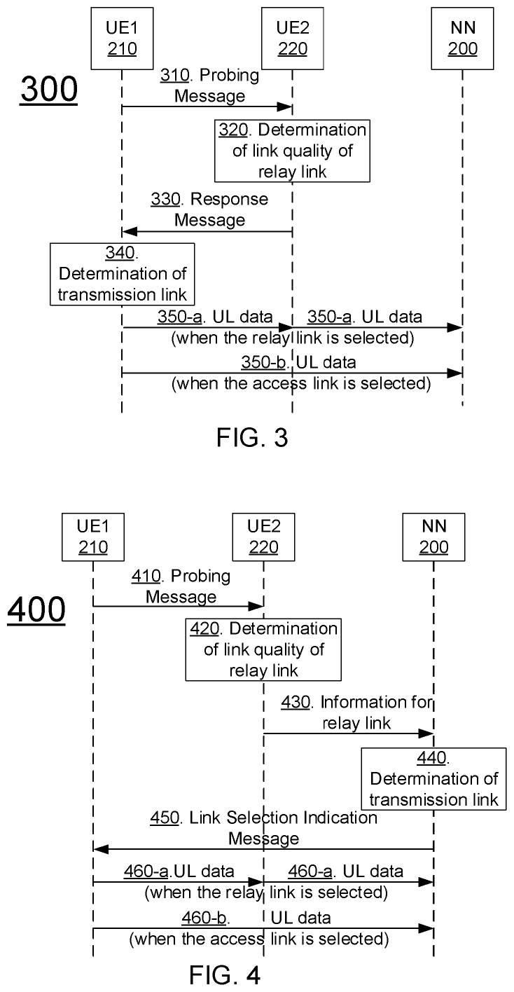

Next, some specific embodiments for illustrating how to select a link for transmission will be described in details with reference to FIG. 3 through FIG. 8. However, please note that these embodiments are merely examples for explaining the principles of the present disclosure, rather than limiting the scope of the present disclosure, and therefore the present disclosure is not limited thereto.

FIG. 3 is a diagram illustrating an exemplary method 300 for link selection in a form of message flow among the different nodes shown in FIG. 2 according to an embodiment of the present disclosure.

As shown in FIG. 3, UE1 210 may first transmit a probing message to UE2 220 via the relay link 225 therebetween at step 310. Please note that the probing message may be transmitted from UE1 210 to UE2 220, for example, in a unicast, multicast, or broadcast manner.

Further, the triggering of the step 310 is at least partially based on the UE1 210's power/energy situation, e.g., remained available energy, power consumption level, whether there is an external power supply, etc. For example, when UE1 210 is in a bad power/energy situation, e.g. the remained available energy is lower than a certain level, it may transmit a probing message (e.g. a discovery message) over its relay link 225 to UE2 220. In some embodiments, the probing message may comprise information about the link quality of the current access link 213 of UE1 210 or information from which the link quality of the current access link 213 of UE1 210 can be derived.

At step 320, upon receipt of the probing message, UE2 220 may determine the link quality of the relay link 225. In some embodiments, the link quality of the relay link 225 may be measured at UE2 220, e.g. by measuring signal quality of the reference signals received together with the probing message.

At step 330, UE2 220 may transmit a response message to UE1 210 to inform UE1 210 of the determined link quality of the relay link 225. In some embodiments, the response message may comprise information from which the link quality of the relay link 225 may be derived.

At step 340, upon receipt of the response message, UE1 210 may determine the link quality of the relay link 225, for example, by deriving the link quality based on the received information in the response message, and then determine which link to be used for UL data transmission and/or DL data reception for UE1 210. Several factors, such as power status, the link quality of the access link 213, the link quality of the relay link 225, or any combination thereof, may be accounted for when the determination is made. Some specific examples on how to determine the link will be given below.

For example, UE1 210 may compare the link quality of the relay link 225 and the link quality of the access link 213, and selects the relay link 225 for transmission in response to determining that the link quality of the relay link 225 is better than the link quality of the access link 213, e.g., the relay link 225 having a higher Signal to Noise plus Interference Ratio (SNIR) or a higher bandwidth. On the other hand, UE1 210 may select the access link 213 for transmission in response to determining that the link quality of the relay link 225 is worse than the link quality of the access link 213.

In addition to the link quality comparison, the power status of UE1 210 is also considered in some embodiments. For example, in the case where UE1 210 has a very low remained power and some UL data to transmit, UE1 210 may choose the relay link 225 instead of the access link 213 even if the access link 213 may have a better link quality because the access link 213 has a narrower bandwidth than that of the relay link 225 and therefore transmission via the relay link 225 may reduce the total transmission time of UE1 210, thereby saving more energy. Once the transmission link is determined, UE1 210 may transmit its UL data via the determined one of the access link 213 and the relay link 225. For example, if UE1 210 decides to choose the relay link 225 for UL data transmission, then the UL data may be transmitted to UE2 220 via the relay link 225 and forwarded by UE2 220 to the network node 200 via the access link 223 of UE2 220 at step 350-a. For another example, if UE1 210 decides to choose the access link 213 for UL data transmission, then the UL data may be transmitted to the network node 200 directly via the access link 213 at step 350-b.

In some other embodiments, once the transmission link is determined, UE1 210 may inform the network node 200 of its decision via either the access link 213 or the relay link 225, and the network node 200 may transmit the DL data via the determined one of the access link 213 and the relay link 225 to UE1 210.

In such a manner, UE1 210 may choose the most cost-efficient link to transmit its UL data or receive its DL data, in terms of power saving, bandwidth optimization, etc.

Further, please note that the determination of the transmission link may be made at some other node than UE1 210. For example, FIG. 4 is a diagram illustrating an exemplary method 400 for link selection in a form of message flow among the different nodes shown in FIG. 2 according to another embodiment of the present disclosure. The major difference between the embodiments shown in FIG. 3 and FIG. 4 is that the determination of the transmission link is transferred from UE1 210 to the network node 200.

The method 400 may begin with the steps 410 and 420 which are substantially same as steps 310 and 320 shown in FIG. 3, and therefore the description thereof is omitted for simplicity.

At step 430, instead of transmitting the information from which the link quality of the relay link 225 is derivable to UE1 210, the information is transmitted to the network node 200.

At step 440, upon receipt of the response message, the network node 200 may determine the link quality of the relay link 225, for example, by deriving the link quality based on the received information in the response message, and then determine which link to be used for UE1 210's UL data transmission and/or DL data reception. Similar to the step 340, several factors, such as power status, the link quality of the access link 213, the link quality of the relay link 225, or any combination thereof, may be accounted for when the determination is made.

Once the transmission link is determined, the network node 200 may inform UE1 210 of the determined link for data transmission, for example, by transmitting a link selection indication message to UE1 210 explicitly at the step 450. In an alternative embodiment, UE1 210 may be informed of this decision implicitly, for example, by transmitting the DL data to UE1 210 via the selected link, and upon receipt of the DL data, UE1 210 may assume that the network node 200 has decided the link over which the DL data is received, as the selected link for UE1 210's UL data transmission.

Upon receipt of the link selection indication message at UE1 210, UE1 210 itself may thus determine the link for its UL data transmission and then transmit its UL data via the determined one of the access link 213 and the relay link 225 at step 460-a or 460-b.

Further, in the embodiments shown in FIG. 3 and FIG. 4, information from which the link quality of the relay link 225 may be derived is transmitted from UE2 220 to either UE1 210 or the network node 200. However, the present disclosure is not limited thereto. For example, in some other embodiments, when UE2 220 determines that the relay link 225 has a worse link quality than that of the access link 213, which is determined at UE2 220 based on the information included in the probing message received at step 310 or 410, UE2 220 may transmit a message without the information from which the link quality of the relay link 225 to UE1 210 or the network node 220. Upon receipt of such a message, i.e. when the information from which the link quality of the relay link 225 is derivable is missing from the message, UE1 210 or the network node 200 may determine that the access link 213 is better by default and make the decision accordingly. For another example, when UE2 220 determines that the relay link 225 has a better link quality than that of the access link 213, UE2 220 may transmit a message without the information from which the link quality of the relay link 225 to UE1 210 or the network node 220. Upon receipt of such a message, i.e. when the information is missing from the message, UE1 210 or the network node 200 may determine that the relay link 225 is better by default and make the decision accordingly.

More generally, in some embodiments, the missing of either the information from which the link quality of the relay link 225 may be derived or information from which the link quality of the access link 213 may be derived can be interpreted by the recipient(s) of the message, by default, as a better link quality of the access link 213. In some other embodiments, the missing of the information in the message can be interpreted by the recipient(s) of the message, by default, as a better link quality of the relay link 225. In other words, as long as the transmitting side and the receiving side reach an agreement on how to interpret such a missing of information, the mechanism works well.

Further, although FIG. 3 and FIG. 4 show embodiment in which the determination of link is performed at either UE1 210 or the network node 200, the present disclosure is not limited thereto. For example, the determination may be made at UE2 220 or any other entity not shown.

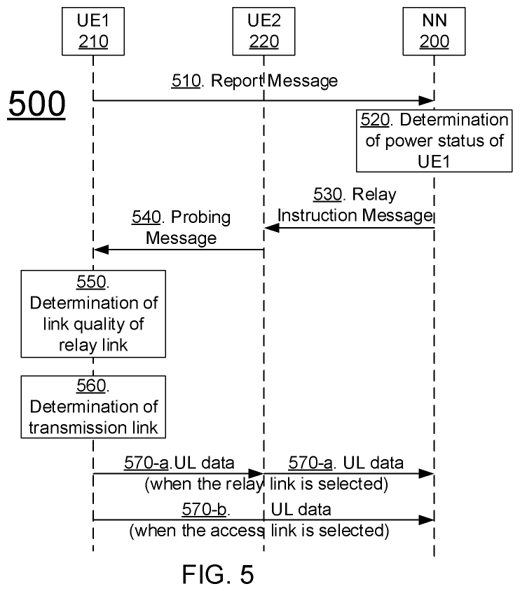

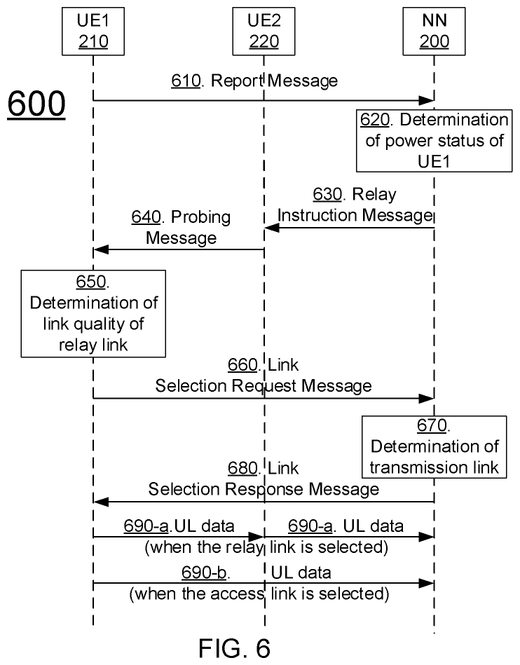

Next, some embodiments where the link quality of the relay link 225 is determined at UE1 210 instead of UE2 220 will be described with reference to FIG. 5 and FIG. 6.

FIG. 5 is a diagram illustrating an exemplary method 500 for link selection in a form of message flow among the different nodes shown in FIG. 2 according to yet another embodiment of the present disclosure.

As shown in FIG. 5, UE 210 may first transmit a report message to the network node 200 to report its status comprising but not limited to information on power status, link status, etc. at step 510.

At step 520, upon receipt of the report message, the network node 200 may determine the power status or any other status of UE1 210 involved in the link selection, and determine whether a link selection (a link change) is needed for UE1 210 or not.

When it is determined at the network node 200 that UE1 210 should or may transmit its UL data via a certain link (e.g. different than the current link for transmission), for example, via the relay link 225 between UE1 210 and UE2 220 instead of the access link 213, the network node 200 may, at step 530, transmit a relay instruction message to UE2 220 to instruct UE2 220 initiate a link selection procedure for UE1 210. The selection of UE2 220 may be made randomly or based on a certain criterion, for example, based on a list of relay UEs maintained at the network node 20 as will be described later.

Upon receipt of the relay instruction message, UE2 220 may transmit a probing message to UE1 210 at step 540. Similar to the probing message transmitted at step 310 or 410, the probing message transmitted at step 540 may comprise information from which the link quality of the relay link 225 can be derived. For example, the probing message may comprise an indicator for the link quality of the relay link 225 which is measured by UE2 220. For another example, UE1 210 may measure the signal quality of the reference signals transmitted together with the probing message and determine the link quality of the relay link 225 at least partially based on the measured signal quality, for example, based on the reciprocity of the relay link 225 in different directions.

At step 550, UE1 210 may determine the link quality of the relay link 225 at least partially based on the probing message, for example, in a way described above.

At step 560, UE1 210 may determine which link is used for UL data transmission, for example, in a way similar to step 340.

Once the transmission link is determined, UE1 210 may transmit its UL data via the determined one of the access link 213 and the relay link 225 at step 570-a/570-b, similar to step 350-a/350-b.

Further, please note that the determination of the transmission link may be made at some other node than UE1 210. For example, FIG. 6 is a diagram illustrating an exemplary method 600 for link selection in a form of message flow among the different nodes shown in FIG. 2 according to a further embodiment of the present disclosure. The major difference between the embodiments shown in FIG. 5 and FIG. 6 is that the determination of the transmission link is transferred from UE1 210 to the network node 200.

The method 600 may begin with the steps 610, 620, 630, 640, and 650 which are substantially same as steps 510, 520, 530, 540, and 550 shown in FIG. 5, and therefore the description thereof is omitted for simplicity.

At step 660, instead of making the decision at UE1 210, a link selection request message comprising the information from which the link quality of the relay link 225 is derivable is transmitted to the network node 200.

At step 670, upon receipt of the link selection request message, the network node 200 may determine the link quality of the relay link 225, for example, by deriving the link quality based on the received information in the link selection request message, and then determine which link to be used for UE1 210's UL data transmission and/or DL data reception. Similar to the step 440, several factors, such as power status, the link quality of the access link 213, the link quality of the relay link 225, or any combination thereof, may be accounted for when the determination is made.

Once the transmission link is determined, the network node 200 may inform UE1 210 of the determined link for data transmission, for example, by transmitting a link selection response message to UE1 210 explicitly at step 680. In an alternative embodiment, UE1 210 may be informed of this decision implicitly, for example, by transmitting the DL data to UE1 210 via the selected link, and upon receipt of the DL data, UE1 210 may assume that the network node 200 has decided the link over which the DL data is received, as the selected link for UE1 210's UL data transmission.

Upon receipt of the link selection response message at UE1 210, UE1 210 itself may thus determine the link for its UL data transmission and then transmit its UL data via the determined one of the access link 213 and the relay link 225 at step 690-a or 690-b.

In the embodiments described with reference to FIG. 3-FIG. 6, only the power status or any other status of UE1 210 is considered when making the decision of which link to use. However, in some other embodiments, the power status or any other status of UE2 220 or any other nodes involved may be accounted for when making the decision. For example, UE2 220 itself may have a power issue such as low battery, a network issue such as insufficient network bandwidth, or any other issue which may affect the decision of which link to use or even result in an inability of functioning as a relay node. In such cases, these factors may be reflected by an offset to the link quality when the decision is made. For example, if UE2 220 has a low/high power status, then the link quality of the relay link 225 may be adjusted by a low/high or negative/positive offset. In this way, if UE1 210 has a worse link quality of the access link 213 than that of the relay link 225, but not worse than the link quality of the relay link 225 plus a negative offset which indicates a lower power status at UE2 220, then UE1 210 may choose the access link 213 instead of the relay link 225. For another example, if UE1 210 has a worse link quality of the access link 213 than that of the relay link 225, but not worse than the link quality of the relay link 225 plus a negative offset which indicates a narrower bandwidth at UE2 220, then UE1 210 may choose the access link 213 instead of the relay link 225.

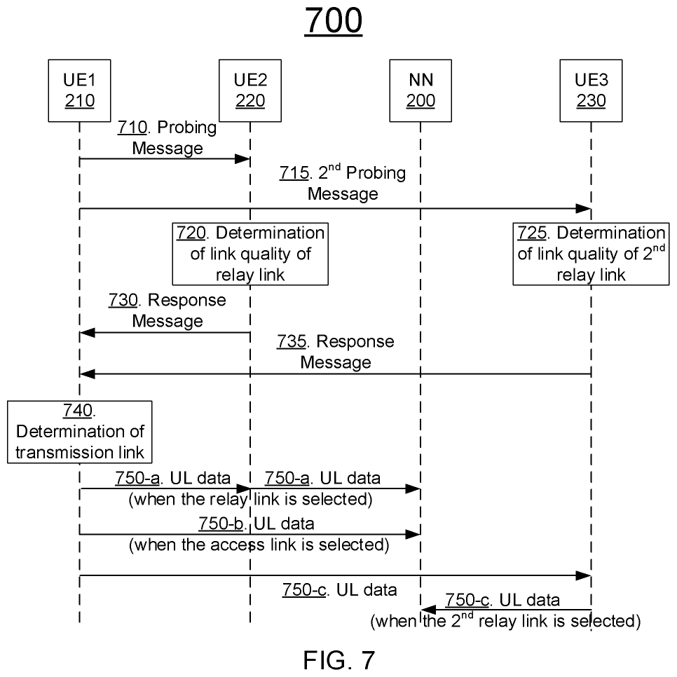

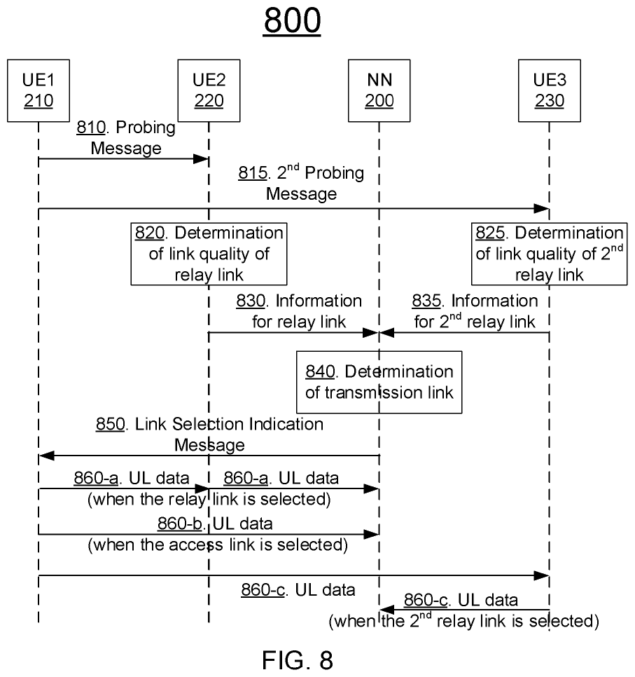

Further, the offset may be used, for example, when the power status, network bandwidth, or the like reaches a certain level, such as the remained energy level higher/lower than a (pre)configured threshold. Furthermore, the offset may be either configured by the relay capable UE itself (e.g. UE2 220) or by the network (e.g. the network node 200) based on the reported power/energy situation and then informed to the UE (e.g. UE1 210 or UE2 220). Optionally the offset could be applied only for selection between indirect paths via different relay capable UEs, which will be described below with reference to FIG. 7 and FIG. 8. Alternatively two different offsets could be introduced, one for selection between direct path and indirect path while the other for selection between different indirect paths.

Further, please note that a UE may indicate whether it is capable and ready to be a potential relay UE, i.e., if it has enough power/energy and capability to act as relays without impacting their normal functionalities. This capability may be signaled by the capability exchange mechanism between the UEs and the NW. For example, in the embodiments shown in FIG. 3-FIG. 6, before the methods begin, UE2 220 may transmit a capability message to the network node 200 to report its status, e.g., potential relay or normal UE, depending on its own power consumption or channel conditions. Further, UE2 220 may actively or passively update its status maintained at the network node 200 to reflect its current power status, network status, or any other factors which will be considered when making the link selection, either regularly or irregularly. In this way, the network node 200 may maintain a list of relay UEs and choose one of them (e.g. UE2 220) when UE1 210 is requesting for a relay UE, for example, as shown in FIG. 5 and FIG. 6.

Further, if UE1 210 is operated in a Mode 1 transmission mode, then the allocation of resources for the side link or the relay link 225 may be controlled by the network node 200. In such a case, when the indirect path (e.g. the relay link 225+the access link 223) is selected, UE1 210 may still use its own access path to transmit e.g. signaling. For instance, UE1 210 may adopt mode 1 resource allocation (RA) in sidelink towards relay UE, in which case UE1 210 may send a scheduling request (SR) or a buffer status report (BSR) message to the network node 200 and receives a side link grant from the network node 200 via the access link 213.

Further, in some embodiments, once the link selection mechanism has been triggered and the relay link is selected following the previous embodiments, the UE1 210 could inform the network node 200 that some of the traffic that will be received by UE2 220 is actually Uu traffic that will be forwarded by the UE2 220 further over the Uu interface or the access link 223. In such a case, two different options can be provided:
Separate SR/BSR is defined for relayed traffic and non-relayed traffic.
(Pre)configure LCH(s)/LCG(s) dedicated for relayed traffic.

In some embodiments, when mode 1 RA is used, UE1 210 may inform the network node 200 of both kinds of SR/BSR or include in BSR LCG(s) for both relayed and non-relayed traffic (if both kinds of traffic exist). Further, when mode 2 RA is used, UE1 210 may just inform the network node 200 of SR/BSR for relayed traffic or include in BSR only LCG(s) for relayed traffic (if that kind of traffic exist).

In this way, the network node 200 could aware of the amount of relayed traffic and non-relayed traffic. This information could be used to optimize scheduling of side link and/or Uu. For example:
Allocate sidelink grant dedicated for relayed traffic and/or non-relayed traffic. The network node 200 may indicate which kind of traffic should be prioritized when using a certain sidelink grant.
The network node 200 may reserve UL resources for the access link 223 between UE2 220 and the network node 200 in advance based on the amount of traffic that needs to be relayed. In this way, the end to end delay of the indirect path communication could be reduced. In this case, the UL resources should not overlap in time with the SL resources granted to UE2 220 and UE1 210.

According to this embodiment, there are two options for signaling the resources that UE2 220 should use for the forwarding of the information using the access link 223.
Option 1: UE1 210 forwards the information received from the network node 200 regarding the granted resources to UE2 220 along with the message to be forwarded.
Option 2: the network node 220 sends this information to UE2 220 directly via the access link 223.

Please note that although FIG. 3-FIG. 6 show the embodiments in which only one relay UE is involved, the present disclosure is not limited thereto. For example, some embodiments in which more than one relay UE is involved in the link selection procedure will be described in detail with reference to FIG. 7 and FIG. 8.

FIG. 7 is a diagram illustrating an exemplary method 700 for link selection along with its message flow among the different nodes shown in FIG. 2 according to further another embodiment of the present disclosure. Since the steps 710, 720, 730, 750-a/750-b are substantially same as steps 310, 320, 330, and 350-a/350-b shown in FIG. 3, the description thereof is omitted for simplicity.

In addition to the above steps, the method 700 may further comprise steps 715, 725, 735, and 740. At step 715, UE1 210 may transmit another (second) probing message to UE3 230 via the relay link 235 therebetween. Please note that the second probing message may be transmitted from UE1 210 to UE3 230, for example, in a unicast, multicast, or broadcast manner. For example, in a case where both of the probing message destined to UE2 220 and the second probing message are transmitted in a multicast or broadcast manner, these two probing messages may be actually the same probing message multicasted or broadcasted by UE1 210. In some other embodiments, these two probing messages could be separately transmitted to UE2 220 and UE3 230.

At step 725, upon receipt of the second probing message, UE3 230 may determine the link quality of the relay link 235. In some embodiments, the link quality of the relay link 235 may be measured at UE3 230, e.g. by measuring signal quality of the reference signals received together with the second probing message.

At step 735, UE3 230 may transmit a second response message to UE1 210 to inform UE1 210 of the determined link quality of the relay link 235. In some embodiments, the second response message may comprise information from which the link quality of the relay link 235 may be derived.

At step 740, upon receipt of the response message from UE2 220 and the second response message from UE3 230, UE1 210 may determine the link quality of the relay link 225 and the link quality of the relay link 235, for example, by deriving the link quality based on the received information in the response messages, and then determine which link to be used for UL data transmission and/or DL data reception for UE1 210. Once the link is selected, the UL data may be transmitted via the determined one of the access link 213 (step 750-a), the relay link 225 (step 750-b), and the second relay link 235 (step 750-c).

Several factors, such as power status, the link quality of the access link 213, the link quality of the relay link 225, the link quality of the relay link 235, or any combination thereof, may be accounted for when the determination is made. Further, some further factors may be accounted for when making the link selection, such as, the power status of the UEs (UE1 210, UE2 220, and/or UE3 230), the willingness of UE2 220 and/or UE3 230 being a relay, the capabilities of UE2 220 and/or UE3 230, or any combination thereof. Further, as mentioned above, these factors may be reflected by one or more offsets. For example, UE2 220 may adjust the link quality of the relay link 225 by an offset which reflects its willingness of being a relay. Similarly, UE3 230 may adjust the link quality of the relay link 235 by another offset which reflects its willingness of being a relay. Such offsets may be independent to each other in some embodiments.

Please note that some of the steps related to one relay UE may be independent of some of the steps related to the other relay UE. For example, the steps 710, 720, 730 may be performed before, after, simultaneously with the steps 715, 725, 735 since they are independent to each other. In some embodiments, the network node 200 may instruct UE1 210 to change its relay node from UE2 220 to UE3 230 simply because UE3 230 is the latest registered relay UE at the network node 230 and enables a better overall performance for UE1 210. In such a case, the steps 715, 725, and 735 may be performed after all of the steps 710-750-c are finished.

Similar to FIG. 7 in view of FIG. 3, FIG. 8 shows an embodiment which modifies the embodiment of FIG. 4 by adding another relay UE (UE3 230) into consideration.

FIG. 8 is a diagram illustrating an exemplary method 800 for link selection along with its message flow among the different nodes shown in FIG. 2 according to further another embodiment of the present disclosure. Since the steps 810, 820, 830, 850, 860-a/860-b are substantially same as steps 410, 420, 430, 450, and 460-a/460-b shown in FIG. 3, the description thereof is omitted for simplicity.

In addition to the above steps, the method 800 may further comprise steps 815, 825, 835, and 840. At step 815, UE1 210 may transmit another (second) probing message to UE3 230 via the relay link 235 therebetween. Please note that the second probing message may be transmitted from UE1 210 to UE3 230, for example, in a unicast, multicast, or broadcast manner. For example, in a case where both of the probing message destined to UE2 220 and the second probing message are transmitted in a multicast or broadcast manner, these two probing messages may be actually the same probing message multicasted or broadcasted by UE1 210. In some other embodiments, these two probing messages could be separately transmitted to UE2 220 and UE3 230.

At step 825, upon receipt of the second probing message, UE3 230 may determine the link quality of the relay link 235. In some embodiments, the link quality of the relay link 235 may be measured at UE3 230, e.g. by measuring signal quality of the reference signals received together with the second probing message.

At step 835, UE3 230 may transmit a second message comprising information from which the link quality of the second relay link 235 can be derived to the network node 200 instead of UE1 210 to inform the network node 200 of the determined link quality of the relay link 235.

At step 840, upon receipt of the message from UE2 220 and the second message from UE3 230, the network node 200 may determine the link quality of the relay link 225 and the link quality of the relay link 235, for example, by deriving the link quality based on the received information in the received messages, and then determine which link to be used for UL data transmission and/or DL data reception for UE1 210. Once the link is selected, a link selection indication message may be transmitted to UE1 210 at step 850 and UE1 210 may transmit the UL data via the determined one of the access link 213 (step 860-a), the relay link 225 (step 860-b), and the second relay link 235 (step 860-c).

Further, FIG. 7 and FIG. 8 are merely embodiments described for illustration purpose and therefore the embodiments in which more than one relay UE is involved are not limited thereto. For example, the determination of the link quality of the first and second relay links may be performed at one node, for example, the network node 200, UE1 210, or any other node. For another example, the determination of the link for transmission may be performed at a different node, such as UE2 220 or UE3 230.

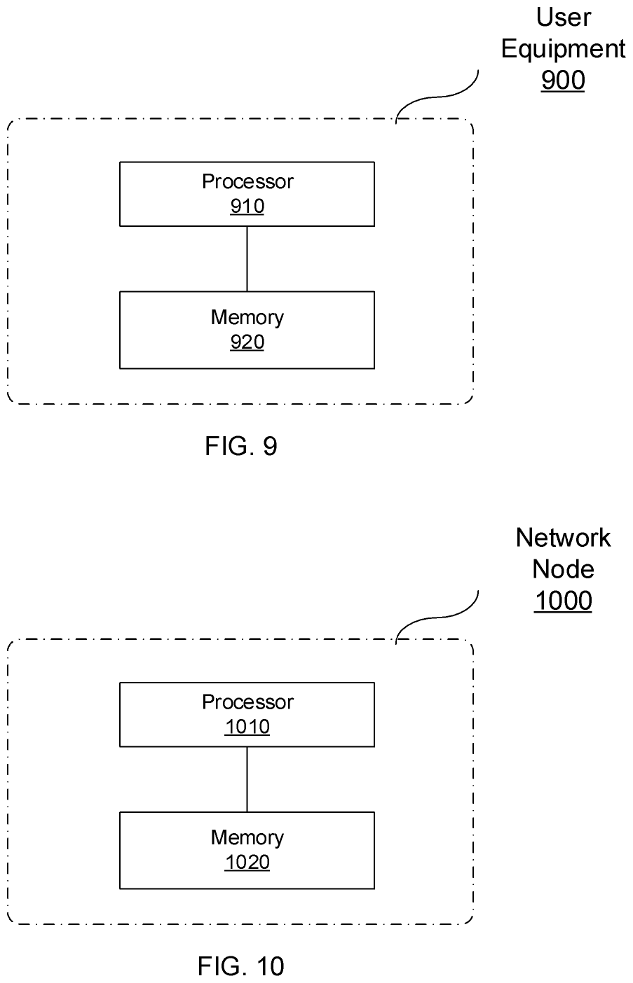

FIG. 9 is a block diagram of a user equipment according to an embodiment of the disclosure. As shown in FIG. 9, the UE 900 may comprise a processor 910 and a memory 920 coupled to the processor 910. The memory 920 contains instructions executable by the processor 910 whereby the UE 900 is operative to perform the methods related to the UE (e.g. UE1 210, UE2 220, UE3 230) as have been described above.

The processor 910 may be implemented, for example, by a CPU (Central processing unit), and could also be implemented by other types of devices. For example, the processor 910 may be implemented by one or more general purpose microprocessors, instruction set processors, and/or special purpose microprocessors such as Application Specific Integrated Circuit (ASICs).

The memory 920 may be implemented by various types of storage devices. For example, the memory 920 may be a volatile storage device such as Random Access Memory (RAM). The memory 920 may also be a non-volatile storage device such as Read Only Memory (ROM). One of ordinary skill in the art can envisage that other types of storage devices can be utilized to implement the memory 920.

FIG. 10 is a block diagram of a network node according to an embodiment of the disclosure. As shown in FIG. 10, the network node 1000 may comprise a processor 1010 and a memory 1020 coupled to the processor 1010. The memory 1020 contains instructions executable by the processor 1010 whereby the network node 1000 is operative to perform the methods related to the network node (e.g. the network node 200) as have been described above.

The processor 1010 may be implemented, for example, by a CPU (Central processing unit), and could also be implemented by other types of devices. For example, the processor 1010 may be implemented by one or more general purpose microprocessors, instruction set processors, and/or special purpose microprocessors such as Application Specific Integrated Circuit (ASICs).

The memory 1020 may be implemented by various types of storage devices. For example, the memory 1020 may be a volatile storage device such as Random Access Memory (RAM). The memory 1020 may also be a non-volatile storage device such as Read Only Memory (ROM). One of ordinary skill in the art can envisage that other types of storage devices can be utilized to implement the memory 1020.

The embodiments of the disclosure can be implemented in computer program products. This arrangement of the disclosure is typically provided as software, codes and/or other data structures provided or coded on a computer readable medium (such as an optical medium, e.g., CD-ROM, a floppy disk or a hard disk), or firmware or micro codes on other mediums (such as one or more ROMs, RAMs or PROM chips), or downloadable software images or shared databases in one or more modules.

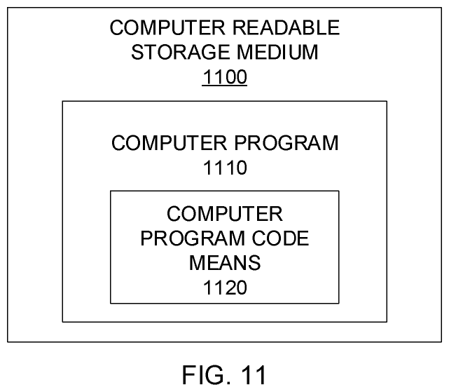

FIG. 11 is a block diagram of a computer readable storage medium having stored thereon a computer program comprising computer program code means according to an embodiment of the disclosure. As shown in FIG. 11, a computer readable medium 1100 has stored thereon a computer program 1110. The computer program 1110 comprises computer program code means 1120 for performing, when executed by at least one processor, the methods according to the disclosure as mentioned above. The computer readable medium 1100 may have the form of a non-volatile or volatile memory, e.g., an Electrically Erasable Programmable Read-Only Memory (EEPROM), a flash memory, a floppy disk, and a hard drive, etc. The computer program code means 1120 may include codes/computer readable instructions in any format.

The disclosure has been described with reference to embodiments and drawings. It should be understood that various modifications, alternations and additions can be made by those skilled in the art without departing from the spirits and scope of the disclosure. Therefore, the scope of the disclosure is not limited to the above particular embodiments but only defined by the claims as attached and equivalents thereof.

### ABBREVIATION EXPLANATION

CA Carrier Aggregation
CBR Channel Busy Ratio
DFN Direct Frame Number
DL Downlink
FDD Frequency Division Duplex
GNSS Global Navigation Satellite System
IE Information Element
MIB Master Information Block
NSPS National Security Public Safety
OoC Out-of-Coverage
RRC Radio Resource Control
RSRP Reference Signal Received Power
RSSI Received Signal Strength Indicator
RX Receive, receiver
SFN System Frame Number
SL Sidelink
TDD Time Division Duplex
TX Transmit, transmitter
UE User Equipment
UL Uplink

1-36. (canceled)

37-70. (canceled)

71. A method at a user equipment (UE) for link selection, the method comprising:
transmitting a probing message to a second UE via a relay link therebetween, both of the UEs being served by a same network node;
determining whether uplink (UL) data is to be transmitted to the network node via the relay link or via an access link between the UE and the network node at least partially based on the link quality of the relay link, which is determined by the second UE at least partially based on the probing message, and the link quality of the access link; and
transmitting the UL data via the determined one of the relay link and the access link.

72. The method according to claim 71, wherein the probing message comprises information from which the link quality of the access link is derivable.

73. The method according to claim 71, wherein the step of determining whether UL data is to be transmitted to the network node via the relay link or via the access link comprises:
receiving, from the second UE, a response message comprising information from which the link quality of the relay link is derivable;
deriving the link quality of the relay link at least partially based on the information; and
determining whether UL data is to be transmitted to the network node via the relay link or via the access link at least partially based on the link quality of the relay link and the link quality of the access link.

74. The method according to claim 73, wherein the step of deriving the link quality of the relay link at least partially based on the information comprises:
determining the link quality of the relay link as being worse than the link quality of the access link in response to determining that the information is absent from the response message.

75. The method according to claim 73, wherein the step of determining whether UL data is to be transmitted to the network node via the relay link or via the access link at least partially based on the link quality of the relay link and the link quality of the access link comprises:
comparing the link quality of the relay link and the link quality of the access link;
determining that the UL data is to be transmitted to the network node via the relay link in response to the comparison result indicating the link quality of the relay link being better than the link quality of the access link; and
determining that the UL data is to be transmitted to the network node via the access link in response to the comparison result indicating the link quality of the relay link being worse than or equal to the link quality of the access link.

76. The method according to claim 71, wherein the step of determining whether the UL data is to be transmitted to the network node via the relay link or via an access link at least partially based on the link quality of the relay link and the link quality of the access link comprises:
determining whether the UL data is to be transmitted to the network node via the relay link or via an access link further based on at least one of:
the willingness of the second UE being a relay UE;
the capability of the second UE; and
the power status of the second UE.

77. The method according to claim 76, wherein the step of determining whether the UL data is to be transmitted to the network node via the relay link or via an access link comprises:
comparing the link quality of the relay link plus an offset and the link quality of the access link, the offset indicating at least one of the willingness of the second UE being a relay UE, the capability of the second UE, and the power status of the second UE;
determining that the UL data is to be transmitted to the network node via the relay link in response to the comparison result indicating the link quality of the relay link plus the offset being better than the link quality of the access link; and
determining that the UL data is to be transmitted to the network node via the access link in response to the comparison result indicating the link quality of the relay link plus the offset being worse than or equal to the link quality of the access link.

78. The method according to claim 71, further comprising:
communicating a second probing message between the UE and a third UE via a second relay link therebetween, both of the UE and the third UE being served by the same network node;
determining whether UL data is to be transmitted to the network node via the relay link, the second relay link, or the access link at least partially based on the link quality of the relay link, the link quality of the second relay link, which is determined at least partially based on the second probing message, and the link quality of the access link, or based on an indication from the network node; and
transmitting the UL data via the determined one of the relay link, the second relay link, and the access link.

79. The method according to claim 78, wherein the step of determining whether the UL data is to be transmitted to the network node via the relay link, the second relay link, or the access link at least partially based on the link quality of the relay link, the link quality of the second relay link, and the link quality of the access link comprises:
determining whether the UL data is to be transmitted to the network node via the relay link, the second relay link, or the access link further based on at least one of:
the willingness of the third UE being a relay UE;
the capability of the third UE; and
the power status of the third UE.

80. The method according to claim 79, wherein the step of determining whether the UL data is to be transmitted to the network node via the relay link, the second relay link, or the access link comprises:
comparing the link quality of the relay link plus an offset, the link quality of the second relay link plus a second offset, and the link quality of the access link, the offset indicating at least one of the willingness of the second UE being a relay UE, the capability of the second UE, and the power status of the second UE, and the second offset indicating at least one of the willingness of the third UE being a relay UE, the capability of the third UE, and the power status of the third UE;
determining that the UL data is to be transmitted to the network node via the relay link in response to the comparison result indicating the link quality of the relay link plus the offset being the best among all three link qualities;
determining that the UL data is to be transmitted to the network node via the second relay link in response to the comparison result indicating the link quality of the second relay link plus the second offset being the best among all three link qualities; and
determining that the UL data is to be transmitted to the network node via the access link in response to the comparison result indicating the link quality of the access link being the best among all three link qualities.

81. The method according to claim 80, wherein the first offset is independent to the second offset.

82. The method according to claim 71, wherein the step of determining whether UL data is to be transmitted to the network node via the relay link or via the access link further comprises:
determining that at least a part of the UL control plane data is to be transmitted to the network node via the access link while the UL user plane data is to be transmitted to the network node via the relay link.

83. The method according to claim 71, further comprising:
transmitting, to the network node, a resource allocation request message indicating the amount of UL data to be transmitted via the relay link.

84. The method according to claim 83, wherein the resource allocation request message is one of a scheduling request (SR) message, a buffer status request (BSR) message, or a message requesting for allocation of one or more logical channels or logical channel groups.

85. The method according to claim 83, further comprising:
receiving, from the network node, a resource allocation response message indicating the resources allocated to the second UE for forwarding the UL data; and
transmitting, to the second UE, the resource allocation response message.

86. A method at a second user equipment (UE) for facilitating link selection, the method comprising:
transmitting, to a network node which serves the second UE, a relay capability message indicating at least one of its willingness, its capability, and its power status for functioning as a relay UE; and
transmitting, to the network node or a first UE, a message comprising information from which link quality of a relay link between the first UE and the second UE is derivable.

87. The method according to claim 86, wherein before the step of transmitting, to the network node or a first user equipment (UE), a message comprising information from which link quality of a relay link between the first UE and the second UE is derivable, the method further comprises:
receiving a probing message from a first UE, which is also served by the network node, via a relay link between the first UE and the second UE;
determining the link quality of the relay link at least partially based on the received probing message.

88. The method according to claim 86, further comprising:
receiving, from the network node, a relay instruction message instructing the second UE to function as a relay UE for a first UE.

89. The method according to claim 87, further comprising:
receiving, from the network node or the first UE, a message comprising resource allocation indicating resources allocated by the network node for relaying UL data for the first UE to the network node; and
relaying the UL data from the first UE to the network node by using the allocated resources.

90. A user equipment (UE), comprising:
a processor; and
a memory storing instructions which, when executed by the processor, cause the processor to control the UE to:
transmit a probing message to a second UE via a relay link therebetween, both of the UEs being served by a same network node;
determine whether uplink (UL) data is to be transmitted to the network node via the relay link or via an access link between the UE and the network node at least partially based on the link quality of the relay link, which is determined by the second UE at least partially based on the probing message, and the link quality of the access link; and
transmit the UL data via the determined one of the relay link and the access link.

91. A method at a network node for facilitating link selection, the method comprising:
receiving, from a second user equipment (UE), a message comprising information from which link quality of a relay link between a first UE and the second UE is derivable;
determining whether uplink (UL) data to be transmitted by the first UE is to be transmitted to the network node via the relay link or via an access link between the UE and the network node at least partially based on the link quality of the relay link, which is determined at least partially based on the information, and the link quality of the access link; and
transmitting, to the first UE, a link selection indication message indicating whether the UL data is to be transmitted to the network node via the relay link or the access link based on the result of the determination.

92. The method according to claim 91, further comprising:
deriving the link quality of the relay link at least partially based on the information.

93. The method according to claim 92, wherein the step of deriving the link quality of the relay link at least partially based on the information:
determining the link quality of the relay link as being worse than the link quality of the access link in response to determining that the information is absent from the message.

94. The method according to claim 92, wherein the step of determining whether UL data to be transmitted by the first UE is to be transmitted to the network node via the relay link or via the access link comprises:
comparing the link quality of the relay link and the link quality of the access link;
determining that the UL data is to be transmitted to the network node via the relay link in response to the comparison result indicating the link quality of the relay link being better than the link quality of the access link; and
determining that the UL data is to be transmitted to the network node via the access link in response to the comparison result indicating the link quality of the relay link being worse than or equal to the link quality of the access link.

95. The method according to claim 91, further comprising:
receiving, from the first UE, a report message reporting the first UE's energy status;
determining whether the first UE needs a relay link at least partially based on its energy status; and
transmitting, to the second UE, a relay instruction message instructing the second UE to function as a relay UE for the first UE.

96. The method according to claim 91, further comprising:
receiving, from the first UE, a link selection request message requesting link selection for the first UE, the link selection request message comprising information from which the link quality of the relay link is derivable;
determining whether the UL data is to be transmitted to the network node via the relay link or via the access link at least partially based on the information and the link quality of the access link; and
transmitting, to the first UE, a link selection response message indicating the result of the determination.

97. The method according to claim 91, wherein the step of determining whether the UL data is to be transmitted to the network node via the relay link or via the access link at least partially based on the link quality of the relay link and the link quality of the access link comprises:
determining whether the UL data is to be transmitted to the network node via the relay link or via the access link further based on at least one of:
the willingness of the second UE being a relay UE;
the capability of the second UE; and
the power status of the second UE.

98. The method according to claim 97, wherein the step of determining whether the UL data is to be transmitted to the network node via the relay link or via the access link comprises:
comparing the link quality of the relay link plus an offset and the link quality of the access link, the offset indicating at least one of the willingness of the second UE being a relay UE, the capability of the second UE, and the power status of the second UE;
determining that the UL data is to be transmitted to the network node via the relay link in response to the comparison result indicating the link quality of the relay link plus the offset being better than the link quality of the access link; and
determining that the UL data is to be transmitted to the network node via the access link in response to the comparison result indicating the link quality of the relay link plus the offset being worse than or equal to the link quality of the access link.

99. The method according to claim 91, further comprising:
receiving another message comprising information from which link quality of a second relay link between the first UE and a third UE is derivable;
determining whether the UL data is to be transmitted to the network node via the relay link, the second relay link, or the access link at least partially based on the link quality of the relay link, the link quality of the second relay link, which is determined at least partially based on the other message, and the link quality of the access link; and
transmitting, to the first UE, a link selection indication message indicating whether the UL data is to be transmitted to the network node via the relay link, the second relay link, or the access link.

100. The method according to claim 91, wherein the step of determining whether UL data is to be transmitted to the network node via the relay link or via the access link further comprises:
determining that at least a part of the UL control plane data is to be transmitted to the network node via the access link while the UL user plane data is to be transmitted to the network node via the relay link.

101. The method according to claim 91, further comprising:
receiving, from the first UE, a resource allocation request message indicating the amount of UL data to be transmitted via the relay link.

102. The method according to claim 101, wherein the resource allocation request message is one of a scheduling request (SR) message, a buffer status request (BSR) message, or a message requesting for allocation of one or more logical channels (LCHs) or logical channel groups (LCGs).

103. The method according to claim 102, further comprising:
transmitting, to the first UE or the second UE, a resource allocation response message indicating the resources allocated to the second UE for forwarding the UL data.

104. A network node, comprising:
a processor; and
a memory storing instructions which, when executed by the processor, cause the processor to control the network node to:
receive, from a second user equipment (UE), a message comprising information from which link quality of a relay link between a first UE and the second UE is derivable;
determine whether uplink (UL) data to be transmitted by the first UE is to be transmitted to the network node via the relay link or via an access link between the UE and the network node at least partially based on the link quality of the relay link, which is determined at least partially based on the information, and the link quality of the access link; and
transmit, to the first UE, a link selection indication message indicating whether the UL data is to be transmitted to the network node via the relay link or the access link based on the result of the determination.
